(19) United States
(12) Patent Application Publication
(10) Pub. No.: US 2003/0074344 A1
(43) Pub. Date: Apr. 17, 2003

(54) Method of and apparatus for managing compressible data files on a recording medium

(76) Inventor: Wilhelmus Hendrikus Alfonsus Bruls, Eindhoven (NL)

Correspondence Address: U.S. Philips Corporation, 580 White Plains Road, Tarrytown, NY, 10591, US

(21) Appl. No.: 10/208,676

(22) Filed: Jul. 30, 2002

(30) Foreign Application Priority Data
Aug. 3, 2001 (EP) 01202949.2

(51) Int. Cl. G06F 7/00

(52) U.S. Cl. 707/1

(57) ABSTRACT

A method of managing compressible data files on a recording medium, the method comprising the steps of

(a) determining or evaluating the space requirement of a data file or part of a data file to be newly recorded onto said recording medium;

(b) if the space requirement exceeds the available space, selecting at least one data file previously recorded on said recording medium;

(c) reproducing said at least one selected data file into at least one data stream (Xᵢₖ) and compressing the data of each data stream by at least one specified reduction factor (aᵢ) for each data stream (Xᵢₖ) to reduce an information amount therein, characterized by

(d) selecting the reduction factors, such that the bitrate (X_{new}) of the data stream to be re-recorded onto said recording medium fulfills the following relation:

$$\begin{matrix}{X}_{new} \leq {\sum }_{k = 1}^{m} {X}_{k , f} = \frac{1}{m} {\sum }_{k = 1}^{m} {\sum }_{i = 1}^{n} ( 1 - {a}_{i} ) {X}_{ik} or & ( i ) \\ {X}_{new} \leq {X}_{i , f} = {\sum }_{i = 1}^{n} ( 1 - {a}_{i} ) \frac{{X}_{i}}{n} = ( n - {\sum }_{i = 1}^{n} {a}_{i} ) \frac{{X}_{i}}{n} = ( 1 - \frac{1}{n} {\sum }_{i = 1}^{n} {a}_{i} ) {X}_{i} or & ( i i ) \\ {X}_{new} \leq {\sum }_{k = 1}^{m} {X}_{k , f} = {\sum }_{k = 1}^{m} {\sum }_{i = 1}^{n} ( 1 - {a}_{i} ) {X}_{ik} = ( 1 - {a}_{i} ) {\sum }_{k = 1}^{m} {X}_{k} = ( 1 - {a}_{i} ) X or & ( i i i ) \\ {X}_{new} \leq {X}_{1 , f} = ( 1 - {a}_{i} ) {X}_{1} , & ( i v )\end{matrix}$$

(iv) X_{new}≦X_{1, f}=(1−a1)X₁,

wherein

X_{new}=bit rate of stream to be newly recorded

aᵢ=reduction factor

Xᵢₖ=bit rate of stream k to be processed with reduction factor aᵢ

X_{k, r}=reduced bit rate of stream k

X_{k, f}=bit rate of deallocated stream k

(e) re-recording the compressed data streams.

(f) recording the data stream to be newly recorded onto said recording medium, while reproducing, compressing and re-recording said selected data stream.

The present invention relates to a method of managing compressible data files on a recording medium, the method comprising the steps of determining or evaluating the space requirement of a data file or part of a data file to be recorded onto said recording medium; if the space requirement exceeds the available space, selecting a data file previously recorded on said recording medium and reproducing said selected data file into at least one data stream and compressing the data of each data stream by at least one specified reduction factor for each data stream to reduce an information amount therein. The invention also relates to an apparatus for managing compressible data files on a recording medium, in particular for carrying out the method according to the invention.

Recently, a new kind of hard storage medium-based video recording has been introduced on the market which records programs automatically based on the consumer's preference. Although these hard storage media have a relatively large recording capacity of 20 hours or even more, it may easily occur that the disk is filled, yet the recorder wants to record a new program, which may be marked as high priority by the consumer. It may also occur that a program takes longer than expected, for example a football match. One option is to delete the oldest program which may not yet be viewed by the consumer. It could also happen that all programs on the disk are marked by the consumer as “KEEP”. In that case, there would be really no space to record that new program.

U.S. Pat. No. 5,764,800 solves the problem that an IC memory card cannot be used with a high efficiency by an image data re-compression device which re-compresses the image data, which have been recorded in the recording medium, with a compression ratio which is higher than another compression ratio with which the image data have been compressed and recorded in the recording medium, so that a potential recordable area, in which other image data can be recorded, will be generated in the recording medium.

Furthermore, EP 0 984 450 A1, which has been used to formulate the preamble parts of patent claims 1 and 5, discloses an information recording and reproducing apparatus provided with a reproducing device for reproducing information which is recorded on a recording medium in advance, a compressing device for compressing the reproduced information to reduce an information amount of the reproduced information and generating a compressing information, and a recording device for re-recording the generated compression information onto the medium. It is possible to re-record the compression information by reproducing the information even if there is no non-recorded area where the reproduced information has never been recorded on the recording medium, for example an optical disk, when the original information is recorded.

It is the object of the invention to provide a method of managing compressible data files on a recording medium which is capable of handling the recording process on the fly.

This object is solved according to the method as defined in claim 1 by selecting the reduction factors, such that the bit rate of the data stream to be newly recorded onto said recording mediums fulfills the following relation:

$${X}_{new} \leq {\sum }_{k = 1}^{m} {X}_{k , f} = \frac{1}{m} {\sum }_{k = 1}^{m} {\sum }_{i = 1}^{n} ( 1 - {a}_{i} ) {X}_{ik} \qquad ( i )$$

X_{new}=bit rate of stream to be newly recorded

aᵢ=reduction factor

Xᵢₖ=bit rate of stream k to be processed with reduction factor aᵢ

X_{k, r}=reduced bit rate of stream k

X_{k, f}=bit rate of deallocated stream k

This is the most general case in which several streams indexed by k are transcoded in several transcoders indexed by i each providing a reduction factor aᵢ.

Generally, for a stream indexed by k:

$${\sum }_{i = 1}^{n} {X}_{ik} = {X}_{k , r} + {X}_{k , f} = {\sum }_{i = 1}^{n} {a}_{i} {X}_{ik} + {X}_{k , f} ⇒ {X}_{k , f} = {\sum }_{i = 1}^{n} ( 1 - {a}_{i} ) {X}_{ik}$$

The method further provides for re-recording the compressed data streams and recording the new data stream onto said recording medium, while reproducing, compressing and re-recording the selected data stream.

The invention uses a general transcoding process to deallocate streams and thereby creates space on which data to be newly recorded can be written. The above general formula (i) includes the following cases:

Transcoding one recorded data stream, for example an MPEG stream, by spreading the successive groups of pictures in such a stream over n transcoders, thus setting k=1 in formula (i) and summing over i=1 . . . n:

$${X}_{new} \leq {X}_{i , f} = {\sum }_{i = 1}^{n} ( 1 - {a}_{i} ) \frac{{X}_{i}}{n} = ( n - {\sum }_{i = 1}^{n} {a}_{i} ) \frac{{X}_{i}}{n} = ( 1 - \frac{1}{n} {\sum }_{i = 1}^{n} {a}_{i} ) X . \qquad ( ii )$$

Transcoding of more than one recorded stream in parallel processes, thus k=1 . . . m and i=1 . . . n, wherein a₁=a₁ . . . =aₙ and

$${X}_{new} \leq {\sum }_{k = 1}^{m} {X}_{k , f} = {\sum }_{k = 1}^{m} {\sum }_{i = 1}^{n} ( 1 - {a}_{i} ) {Xi}_{k} = ( 1 - {a}_{i} ) {\sum }_{k = 1}^{m} {X}_{k} = ( 1 - {a}_{i} ) X \qquad ( iii )$$

$${X}_{ik} = \frac{1}{n} {X}_{k}$$

Transcoding of one recorded stream in real-time reproduction of said stream (n=1):

(iv) X_{new}≦X_{1, f}=(1−a1)X₁,

In a preferred embodiment, the steps of reproducing, compressing and re-recording the data stream to be processed are performed faster than in real-time, wherein preferably the bit rate of the data stream to be newly recorded is selected in accordance with the formula

$${X}_{new} = F \cdot {\sum }_{k = 1}^{m} {X}_{k , f} \qquad ( v )$$

defining a real-time factor F to create an equal bit rate for the new stream, thus

$${X}_{new} = \frac{1}{m} {\sum }_{k = 1}^{m} {\sum }_{i = 1}^{n} ( 1 - {a}_{i} ) {X}_{ik} \qquad ( vi )$$

The above general formula means for the case of one recorded stream a real-time factor of a₁/(1−a₁) or a relation.

| reduction factor | real-time factor |
|---|---|
| 0.60 | 1.5 |
| 0.66 | 2 |
| 0.72 | 2.5 |
| 0.75 | 3 |
| 0.80 | 4 |
| 0.83 | 5 |

PHNL 000344 EP.P (official serial number . . . ) describes a transcoding stream which can operate in a faster than real-time mode and achieve a bit rate reduction with good picture quality.

It is also possible to repeat said transcoding steps at least once, where the second reduction factor can be selected to be identical to the first reduction factor or different therefrom.

It is preferred that a compressed and re-recorded data stream is marked to indicate that said transcoding steps have been performed at least once.

An apparatus for managing compressible data files on a recording medium according to the invention comprises means for determining or evaluating the space requirement of a data file or part of a data file to be recorded on said recording medium; means for selecting a data file previously recorded on said recording medium; means for reproducing said selected data file into at least one data stream and compressing the data of each data stream by at least one specified reduction factor for each data stream to reduce an information amount therein; means for selecting the reduction factor such that the bit rate of the data stream to be recorded onto said recording medium fulfills the above relation (i) or any of the relations (ii), (iii) and (iv); means for re-recording the compressed data streams; means for recording the data stream to be newly recorded onto said recording medium; and control means for controlling said means for recording the data stream to be newly recorded to record while said selected data stream is reproduced, compressed and re-recorded.

It is preferred that said control means comprises a virtual buffer into which a data stream from said means for recording and at least one re-recorded stream from said means for re-recording the compressed data streams are fed, wherein said streams are jointly controlled to fit into said virtual buffer.

A method and an apparatus according to the invention may advantageously be used in a coding scheme as disclosed in WO 00/59234, where an information stream is encoded into a variable bit rate encoded information stream, and the relation between the variable bit rate, the recording time and the storage capacity of a record carrier is estimated. The deviation of the estimated recording time from the true recording time is kept within predefined limits, and it is prevented that deviations from several successive recordings accumulate. So, in particular, it is preferred to use a method and an apparatus according to the invention in a process of encoding an input information stream in one operation, which input information stream comprises a stream of information units [R_{IN}], comprising an encoding step of converting the input information stream into an output information stream, said output information stream comprising a variable stream of information units [R_{ENC}], the variable stream of information units being between a minimum value R_{ENC,MIN} and a maximum value R_{ENC,MAX}, while the effect of the encoding step can be influenced by means of at least one control signal [R], wherein the process comprises a measuring step in which, at any instant T, a quantity of information units [ENC_{OUT}(T)] generated in the encoding step, reduced by a chosen average value of the variable stream of information units in the output information stream [R_{ENC,AVER}] multiplied by the instant T, is recorded in accordance with the formula ENC_{OUT}(T)−R_{ENC,AVER}−T], and a comparison step in which the quantity of information units [ENC_{OUT}(T)−R_{ENC,AVER}−T recorded in the measuring step is compared with at least one criterion, and in which at least one signalizing signal [S] is generated, and a control step in which at least one control signal [R] is generated, in which the state of the control signal depends on the state of at least one of the signalizing signals [S] generated in the comparison step, and which control signal influences the effect of the encoding step.

The invention will be further explained with reference to the accompanying drawings, in which:

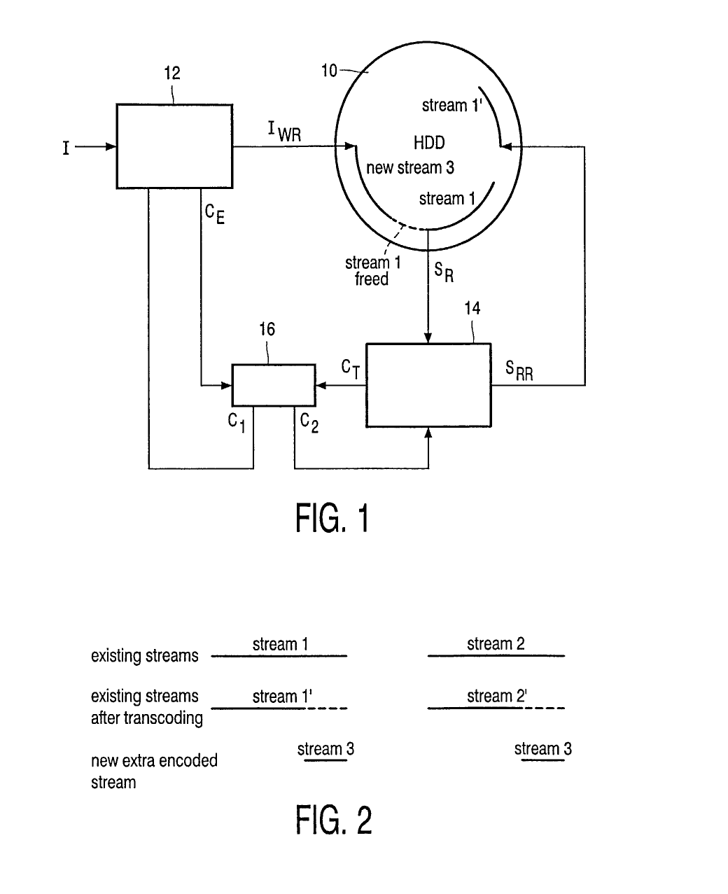

FIG. 1 is a block diagram illustrating an embodiment of the present invention; and

FIG. 2 is a view showing the transcoding scheme of the present invention.

In FIG. 1, a hard disk drive (HDD) 10 holds a hard disk as a recording medium for recording programs represented by data streams. Stream 1 has been previously recorded on the hard disk in said hard disk drive 10. The input signal of a program newly to be recorded is applied via line I to an encoder 12, operating, for example, with the MPEG standard, and is written as signal on line I_{WR} to the hard disk with a bit rate of 2.66 Mbs. It is now recognized by a control unit (not shown) that the space required for the new data stream exceeds that available on hard disk 10. Stream 1 is selected to be transcoded by said control unit. It is read out from the disk faster than real-time via signal line S_{R}, for example with a bit rate of 2*4 Mbs, into a transcoder 14, in which the data stream is re-compressed and read out to the hard disk 10 via signal line S_{RR} with a bit rate faster than real-time, for example 2*2.66 Mbs where it is re-recorded, symbolized by stream 1′.

Since it is optimal for disk systems to use a variable bit rate scheme (VBR or CVBR), some buffer space should be available because this bit rate scheme has an element of unpredictability. In this embodiment, the buffer space is provided in the form of a virtual buffer 16 into which the number of bits produced by encoder 12 is given via control line C_{E}. Furthermore, information about the read-out portion of stream 1 is given from transcoder 14 through line C_{T} to virtual buffer 16, which in turn then calculates the deallocated space and sends the result back to encoder 12 via line C₁. On the other hand, virtual buffer 16 gives still needed space to transcoder 14 on line C₂ in order to read out more data streams from hard disk drive 10. The status of the virtual buffer 16 influences both the number of bits produced by the encoder 12 and also the number of bits saved by the faster than real-time transcoding process. At the end of the recording, the virtual buffer value is saved. At the start of a new recording and faster than real-time transcoding, this saved value is used as the initial value for the virtual buffer.

Parallel in time with the transcoding process, the encoded signal on line I_{WR} is written into the deallocated space as new stream 3.

The principle of the invention is illustrated with reference to FIG. 2. In this example, there are two streams 1, 2 each having averaged 4 Mbs. If these streams are transcoded from 4 Mbs to 2.66 Mbs, a space of 1.33 Mbs is deallocated. If this transcoding process is performed twice as fast, the bit rate doubles to 2*1.33 Mbs=2.66 Mbs. Therefore, a new program can be recorded at 2.66 Mbs in the space deallocated by the transcoding process. By reducing the bit rate from 4 Mbs to 2.66 Mbs, there will be some reduction in picture quality which, however, is acceptable.

Streams that have undergone a transcoding process are marked by a flag, or any other indicator of the amount of the accumulated reduction factors. When all streams are flagged, the disk is really full, i.e. re-compressing to a still lower bit rate would lead to unacceptable quality degradation.

There could be more than one level, for example, a first level with a reduction factor of 0.8. If all streams have been marked as having reached the first level, a second level can be applied, again with a factor 0.8 or with a different factor, until a maximum reduction is achieved which still provides for a sufficient image quality.

The features disclosed in the foregoing description, in the claims and/or in the accompanying drawings may, both separately and in any combination thereof, be material for realising the invention in diverse forms thereof.

### REFERENCE NUMERAL LIST

10 HDD Hard disk drive

12 VBR MPEG encoder

14 VBR MPEG transcoder

16 Virtual buffer

I input signal of a program newly to be recorded

I_{WR} encoded signal to be written on HDD

C₁ control line to encoder

C₂ control line to transcoder

S_{R} line of reproduced signal

S_{RR} lien of re-recorded signal

C_{E} control line from encoder

C_{T} control line from transcoder

1. A method of managing compressible data files on a recording medium, the method comprising the steps of
(a) determining or evaluating the space requirement of a data file or part of a data file to be newly recorded onto said recording medium;
(b) if the space requirement exceeds the available space, selecting at least one data file previously recorded on said recording medium;
(c) reproducing said at least one selected data file into at least one data stream (Xᵢₖ) and compressing the data of each data stream by at least one specified reduction factor (aᵢ) for each data stream (Xᵢₖ) to reduce an information amount therein,
characterized by
(d) selecting the reduction factors, such that the bitrate (X_{new}) of the data stream to be re-recorded onto said recording medium fulfills the following relation:
$$\begin{matrix}{X}_{new} \leq {\sum }_{k = 1}^{m} {X}_{k , f} = \frac{1}{m} {\sum }_{k = 1}^{m} {\sum }_{i = 1}^{n} ( 1 - {a}_{i} ) {X}_{ik} or & ( i ) \\ {X}_{new} \leq {X}_{i , f} = {\sum }_{i = 1}^{n} ( 1 - {a}_{i} ) \frac{{X}_{i}}{n} = ( n - {\sum }_{i = 1}^{n} {a}_{i} ) \frac{{X}_{i}}{n} = ( 1 - \frac{1}{n} {\sum }_{i = 1}^{n} {a}_{i} ) {X}_{i} or & ( i i ) \\ {X}_{new} \leq {\sum }_{k = 1}^{m} {X}_{k , f} = {\sum }_{k = 1}^{m} {\sum }_{i = 1}^{n} ( 1 - {a}_{i} ) {X}_{ik} = ( 1 - {a}_{i} ) {\sum }_{k = 1}^{m} {X}_{k} = ( 1 - {a}_{i} ) X or & ( i i i ) \\ {X}_{new} \leq {X}_{1 , f} = ( 1 - {a}_{i} ) {X}_{1} , & ( i v )\end{matrix}$$
(iv) X_{new}≦X_{1, f}=(1−a1)X₁,
wherein
X_{new}=bit rate of stream to be newly recorded
aᵢ=reduction factor
Xᵢₖ=bit rate of stream k to be processed with reduction factor aᵢ
X_{k, r}=reduced bit rate of stream k
X_{k, f} bit rate of deallocated stream k
(e) re-recording the compressed data streams.
(f) recording the data stream to be newly recorded onto said recording medium, while reproducing, compressing and re-recording said selected data stream.

2. The method as claimed in claim 1, characterized in that steps (c), (d) and (e) are performed faster than in real time.

3. The method as claimed in claim 2, characterized in that the bitrate (X_{new}) of the data stream to be newly recorded is selected in accordance with the formula
$${X}_{new} \leq \frac{1}{m} {\sum }_{k = 1}^{m} {\sum }_{i = 1}^{n} ( 1 - {a}_{i} ) {X}_{ik}$$

4. The method as claimed in anyone of claim 1 or 3, characterized in that said steps (c), (d) and (e) are repeated at least once.

5. The method as claimed in claim 4, characterized in that a compressed and re-recorded data stream is marked.

6. The method as claimed in claim 4 or 5, characterized in that steps c), d) and e) are repeated, using a reduction factor different from the reduction factor of a previous sequence of steps c), d) and e).

7. The method as claimed in anyone of claims 4 to 6, characterized in that each reduction factor which is associated with a specific compressed and re-recorded data stream is stored, and that all reduction factors associated with the same data stream are accumulated to indicate a maximum accumulated reduction factor.

8. An apparatus for managing compressible data files on a recording medium, comprising
(a) means for determining or evaluating the space requirement of a data file or part of a data file to be recorded on said recording medium;
(b) means for selecting a data file previously recorded on said recording medium;
(c) means for reproducing said selected data file into at least one data stream and compressing the data of each data stream by at least one specified reduction factor for each data stream to reduce an information amount therein;
characterized by
(d) means for selecting the reduction factor, such that the bit rate of the data stream to be recorded onto said recording medium fulfills the following relation:
$$\begin{matrix}{X}_{new} \leq {\sum }_{k = 1}^{m} {X}_{k , f} = \frac{1}{m} {\sum }_{k = 1}^{m} {\sum }_{i = 1}^{n} ( 1 - {a}_{i} ) {X}_{ik} or & ( i ) \\ {X}_{new} \leq {X}_{i , f} = {\sum }_{i = 1}^{n} ( 1 - {a}_{i} ) \frac{{X}_{i}}{n} = ( n - {\sum }_{i = 1}^{n} {a}_{i} ) \frac{{X}_{i}}{n} = ( 1 - \frac{1}{n} {\sum }_{i = 1}^{n} {a}_{i} ) {X}_{i} or & ( i i ) \\ {X}_{new} \leq {\sum }_{k = 1}^{m} {X}_{k , f} = {\sum }_{k = 1}^{m} {\sum }_{i = 1}^{n} ( 1 - {a}_{i} ) {X}_{ik} = ( 1 - {a}_{i} ) {\sum }_{k = 1}^{m} {X}_{k} = ( 1 - {a}_{i} ) X or & ( i i i )\end{matrix}$$
(iv) X_{new}≦X_{1, f}=(1−a1)X₁,
wherein
X_{new}=bit rate of stream to be newly recorded
aᵢ=reduction factor
Xᵢₖ=bit rate of stream k to be processed with reduction factor a₁
X_{k, r}=reduced bit rate of stream k
X_{k, f}=bit rate of deallocated stream k
(e) means (14) for re-recording the compressed data streams;
(f) means (12) for recording the data stream to be newly recorded onto said recording medium; and
(g) control means (16) for controlling said means (12) for recording the data stream to be newly recorded to record while said selected data stream is reproduced, compressed and re-recorded.

9. The apparatus as claimed in claim 8, characterized in that said control means (16) comprises a virtual buffer into which a data stream from said means (12) for recording and at least one re-recorded stream from said means (14) for re-recording the compressed data streams are fed, wherein said streams are jointly controlled to fit into said virtual buffer.

10. Use of a method as claimed in anyone of claims 1 to 7 in a process of encoding an input information stream in one operation, which input information stream comprises a stream of information units [R_{IN}], comprising an encoding step of converting the input information stream into an output information stream, said output information stream comprising a variable stream of information units [R_{ENC}], the variable stream of information units being between a minimum value R_{ENC,MIN} and a maximum value R_{ENC,MAX}, while the effect of the encoding step can be influenced by means of at least one control signal [R], wherein the process comprises a measuring step in which, at any instant T, a quantity of information units [ENC_{OUT}(T)] generated in the encoding step, reduced by a chosen average value of the variable stream of information units in the output information stream [R_{ENC,AVER}] multiplied by the instant T, is recorded in accordance with the formula ENC_{OUT}(T)−R_{ENC,AVER}−T], and a comparison step in which the quantity of information units [ENC_{OUT}(T)−R_{ENC,AVER}−T recorded in the measuring step is compared with at least one criterion, and in which at least one signalizing signal [S] is generated, and a control step in which at least one control signal [R] is generated, in which the state of the control signal depends on the state of at least one of the signalizing signals [S] generated in the comparison step, and which control signal influences the effect of the encoding step.

11. Use of an apparatus as claimed in claim 8 or 9 to perform a process of encoding an input information stream in one operation, which input information stream comprises a stream of information units [R_{IN}], comprising an encoding step of converting the input information stream into an output information stream, said output information stream comprising a variable stream of information units [R_{ENC}], the variable stream of information units being between a minimum value R_{ENC,MIN} and a maximum value R_{ENC,MAX}, while the effect of the encoding step can be influenced by means of at least one control signal [R], wherein the process comprises a measuring step in which, at any instant T, a quantity of information units [ENC_{OUT}(T)] generated in the encoding step, reduced by a chosen average value of the variable stream of information units in the output information stream [R_{ENC,AVER}] multiplied by the instant T, is recorded in accordance with the formula ENC_{OUT}(T)−R_{ENC,AVER}−T], and a comparison step in which the quantity of information units [ENC_{OUT}(T)−R_{ENC,AVER}−T recorded in the measuring step is compared with at least one criterion, and in which at least one signalizing signal [S] is generated, and a control step in which at least one control signal [R] is generated, in which the state of the control signal depends on the state of at least one of the signalizing signals [S] generated in the comparison step, and which control signal influences the effect of the encoding step.
